(19) United States
(12) Patent Application Publication
(10) Pub. No.: US 2023/0041992 A1
(43) Pub. Date: Feb. 9, 2023

(54) Coffee Maker Foot Pedal Controller

(71) Applicant: Elida Ruiz, Seattle, WA (US)

(72) Inventor: Elida Ruiz, Seattle, WA (US)

(21) Appl. No.: 17/397,744

(22) Filed: Aug. 9, 2021

(51) Int. Cl. A47J 31/46; A47J 31/52

(52) U.S. Cl. CPC A47J 31/461; A47J 31/525; A47J 31/467; A47J 31/521

(57) ABSTRACT

An article of manufacture for providing a foot pedal controlled beverage dispenser is disclosed. The foot pedal controlled beverage dispenser has a beverage dispenser having a beverage storage cavity and a beverage dispenser signal controller, a dispensing valve coupled to the beverage storage cavity and operating under the control of the beverage dispenser signal controller and a foot pedal communicatively coupled to the beverage dispenser signal controller providing an input signal to open the dispensing valve.

### TECHNICAL FIELD

This application relates in general to an article of manufacture for providing a liquid dispensing device, and more specifically, to an article of manufacture providing a foot pedal controlled dispensing coffee maker.

### BACKGROUND

Current coffee dispensers are a high use item that can be unsanitary and difficult to use, especially for coffee dispensers that are located in a public area, for example a cafeteria, take out establishment, and larger workplace. Coffee dispenser users have shared a common handle pump that all other users have touched and typically are not inclined to sanitize their hands after use. Because of the ease in which pathogens can be readily transmitted between individuals when a small number of users do not follow good hygiene practices, a need exists to permit the dispensing of liquid products in public areas using a hands-free controller.

Therefore, a need exists for an article of manufacture for providing a foot pedal controlled dispensing coffee maker. The present invention attempts to address the limitations and deficiencies in prior solutions according to the principles and example embodiments disclosed herein.

### SUMMARY

In accordance with the present invention, the above and other problems are solved by providing a foot pedal controlled dispensing coffee maker according to the principles and example embodiments disclosed herein.

In one embodiment, the present invention is an article of manufacture for providing a foot pedal controlled beverage dispenser. The beverage dispenser has a beverage dispenser having a beverage storage cavity and a beverage dispenser signal controller, a dispensing valve coupled to the beverage storage cavity and operating under the control of the beverage dispenser signal controller and a foot pedal communicatively coupled to the beverage dispenser signal controller providing an input signal to open the dispensing valve.

In another aspect of the present invention, the beverage dispenser further comprises a beverage maker coupled to the beverage storage cavity to supply beverage liquid for dispensing.

In another aspect of the present invention, the beverage dispenser further comprises a valve signal receiver connected to the beverage dispenser signal controller to receive the input signal from a foot pedal signal transmitter within the foot pedal.

In another aspect of the present invention, the input signal is transmitted from the foot pedal signal transmitter to the valve signal receiver using a wired connection.

In another aspect of the present invention, the input signal is transmitted from the foot pedal signal transmitter to the valve signal receiver using a wireless connection.

In another aspect of the present invention, the wireless connection comprises a Bluetooth signal.

In another aspect of the present invention, the beverage storage cavity is a thermally insulated container.

In another aspect of the present invention, the beverage maker automatically refills the beverage storage cavity when the contents is below a defined volume.

In another aspect of the present invention, the beverage maker refills the beverage storage cavity when the contents when instructed by the beverage dispenser signal controller.

In another aspect of the present invention, the beverage dispenser signal controller opens the dispensing valve when receiving the input signal.

In another aspect of the present invention, the beverage dispenser signal controller opens the dispensing valve to dispense a predetermined volume of beverage starting when the input signal is received.

In another aspect of the present invention, the predetermined length of time is measured using a digital counter within the beverage dispenser signal controller.

In another aspect of the present invention, the beverage dispenser further comprises a hand-operated switch communicatively coupled to the beverage dispenser signal controller.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of an article of manufacture providing a foot pedal controlled dispensing coffee maker according to the present invention.

FIG. 2 illustrates a functional diagram of an article of manufacture providing a foot pedal controlled dispensing coffee maker according to the present invention.

FIG. 3 illustrates a control signal diagram of an article of manufacture providing a foot pedal controlled dispensing coffee maker according to the present invention.

### DETAILED DESCRIPTION

This application relates in general to an article of manufacture for providing a liquid dispensing device, and more specifically, to an article of manufacture providing a foot pedal controlled dispensing coffee maker according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual” and “user” refer to an entity, e.g., a human, using an article of manufacture providing a foot pedal controlled dispensing coffee maker associated with the invention. The term user herein refers to one or more users.

The term “invention” or “present invention” refers to the invention being applied for via the patent application with the title “Coffee Maker Foot Pedal Controller.” Invention may be used interchangeably with dispenser.

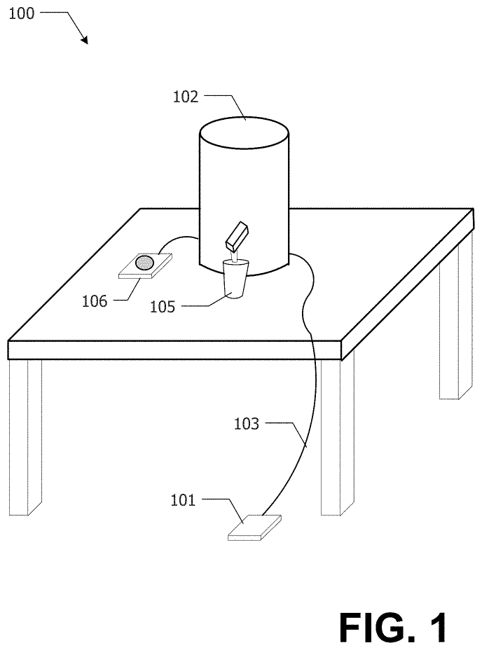

In general, the present disclosure relates to an article of manufacture for providing a foot pedal controlled dispensing coffee maker according to the present invention. To better understand the present invention, FIG. 1 illustrates an example embodiment of an article of manufacture providing a foot pedal controlled dispensing coffee maker according to the present invention. A hands-free beverage dispensing system 100 may be used to allow users to obtain a beverage from a common dispenser 102 without physically handling a control device. The common dispenser 102 is communicatively connected to a foot pedal 101 to allow users to control the dispensing of a beverage into a cup 105 by simply stepping on a foot pedal 101.

The foot pedal 101 provides the common dispenser 102 with a control signal 103 to indicate that a user is instructing the common dispenser 102 to output a liquid beverage to the user's cup 105. The foot pedal 101 generates the control signal 103 as long as the user is pressing the foot pedal 101. The control signal 103 is terminated when the user steps off of the foot pedal 101.

The hands-free beverage dispensing system 100, which may also be known as a coffee maker foot pedal dispenser, addresses the issue of dispensing coffee, or any other beverage, from a common dispenser 102 in a common area of a store, restaurant, hotel, and place of employment that has been touched and used by all the customers throughout the day without being cleaned. The foot pedal 101 replaces a handle on the top of a coffee dispensing spigot by placing a connected foot pedal 101 onto the floor in front of the hands-free beverage dispensing system 100. The user, without having to touch a control device with his/her hands, simply presses on the foot pedal 101 with his/her foot until they have dispensed a desired amount of coffee, or another beverage, into a cup 105 or other drinking container. A hand-operated switch 106 also may be added to the present invention in some embodiments. The hand-operated switch 106 operates in parallel to the foot pedal 101 to operate the hands-free beverage dispensing system 100.

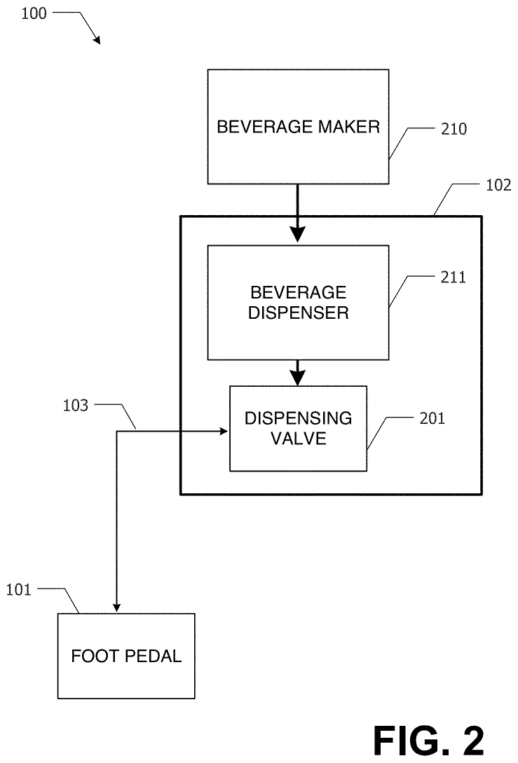

FIG. 2 illustrates a functional diagram of an article of manufacture providing a foot pedal controlled dispensing coffee maker according to the present invention. The hands-free beverage dispensing system 100 comprises the foot pedal 101, the control signal 103 from the foot pedal 101, a dispensing valve 301, a beverage dispenser 211, and a beverage maker 210. While the hands-free beverage dispensing system 100 disclosed herein presents coffee as an exemplary beverage to disclose the functionality of the hands-free beverage dispensing system 100, one skilled in the art recognizes that other beverages may be dispensed using the hands-free beverage dispensing system 100 as recited within the attached claims.

The foot pedal 101 comprises an input switch that may be placed on the floor about the beverage dispenser 211 that may be operated by a user stepping upon the foot pedal 101. When the switch within the foot pedal 101 is closed, the foot pedal 101 activates the control signal 101 to command the beverage dispenser 211 to provide the beverage to the user. When the user removes his or her foot from the foot pedal 101, the control signal 103 is deactivated.

The control signal 103 from the foot pedal 101 provides an indication to the beverage dispenser 211 that a user is requesting that a beverage be dispensed. In a preferred embodiment, the control signal comprises an electrical signal that is energized from a default state when the input switch of the foot pedal 101 is closed. The control signal 103 is transmitted to a dispensing value 301 within a spigot of the beverage dispenser 311. The activation of the control signal 103 causes the dispensing valve to open permitting the beverage within the beverage dispenser 311 to flow out of the spigot. When the control signal 103 is deactivated, the dispensing valve 301 closes to stop the flow of the beverage from the beverage dispenser 311.

In alternate embodiments, the control signal 103 may comprise a hydraulic signal line, a mechanical cable, a wireless connection, or other similar signal mechanism. In the embodiments that utilize a hydraulic signal line and a mechanical cable, depression by the user onto the foot pedal 101 generates a force within the control signal line causing the generated force to be applied to an input to the dispensing valve 301. This force causes the dispensing valve to open until the force is removed when the user steps off of the foot pedal 101. In the embodiment using a wireless connection, a wireless communications channel between the foot pedal 101 and the dispensing valve 301 is implemented using an IR, RF, or similar wireless communications medium. The wireless communications channel may utilize any communications protocol such as Bluetooth™, Wifi, cellular or other known communications protocols. The wireless connection for the control signal 103 operates in a similar manner as the electrical embodiment to generate and to apply an electrical signal to the dispensing valve 301 when the user depresses the foot pedal 101.

The dispensing valve 301 connects an inner beverage storage cavity within the beverage dispenser 211 with an output spigot to provide a path for the beverage to flow when requested by a user. The dispensing valve 301 receives the control signal 103 from the foot pedal 101 that causes the dispensing valve 301 to open. When open, the dispensing valve 301 permits the beverage to flow through the valve. When the control signal 103 is deactivated, the dispensing valve 301 closes to stop the flow of the beverage to the spigot. The dispensing valve 301 and spigot (not shown) may be an integral part of the beverage dispenser 211. In an alternate embodiment, the dispensing valve 301 and spigot may be an additional component coupled to an output from the coffee dispenser 211.

The beverage dispenser 211 provides a container 102 to hold a beverage upon request from the user. The beverage dispenser 211 provides the beverage that is made in the maker 210 and employs a holding container until the foot pedal 101 instructs the dispensing valve 301 to open. The beverage dispenser 211 in a preferred embodiment holds a specific volume of coffee and provides a thermally insulated container to keep the coffee warm between receipt from the beverage maker 210 and the user.

The beverage dispenser 211 may also possess an active thermal control system (not shown) to keep the beverage at a specified temperature. For coffee, this active thermal control system may provide heaters to the beverage storage cavity within the beverage dispenser 211 to keep the coffee warm. For cold beverages, the active thermal control system may transfer heat from within the beverage storage cavity 315 within the beverage dispenser 211 to keep the beverage cold.

Additionally, the beverage storage cavity 315 within the beverage dispenser 211 may hold different volumes of liquid beverages in various embodiments. In embodiments in which a large volume of coffee is dispensed over a short period of time, the beverage dispenser 211 may possess a larger beverage storage cavity 315 to hold a larger volume of beverage that may be periodically made by the beverage maker 210 to replenish the beverage storage cavity 315 as it is emptied. In embodiments in which only a smaller volume of coffee is expected to be consumed, the beverage storage cavity 315 within the beverage dispenser 211 may be significantly smaller as the coffee may wish to be brewed for each customer to ensure fresh coffee is received by all users. For other types of beverages, especially carbonated beverages, storage in an open beverage storage cavity 315 may allow the carbonation to escape and render the beverage less desirable. The beverage dispenser 211 may be configured to match both the type of beverage being served as well as the expected volume to be consumed by customers.

The beverage maker 210 consumes input materials to create the beverage being provided by the beverage dispenser 211. In an embodiment in which coffee is provided, the beverage maker 210 will use coffee beans or ground coffee, and water to brew coffee to provide to the beverage dispenser 211. The beverage maker 210 may include a coffee bean grinder (not shown) if whole coffee beans are used and a water heater to raise the temperature of the water to be passed through the ground coffee beans to create coffee. The coffee beans or grounds may be provided in many forms for use by the beverage maker 210. For other beverages, other input materials may be used. For example, iced tea may be brewed using a similar process used to brew coffee. The beverage maker 210 may add sweeteners and flavoring such as lemon, peach, and raspberry to create different types of iced tea. The beverage maker 210 sends the created beverage to the beverage dispenser 211 for storage within the beverage storage cavity 315 as needed.

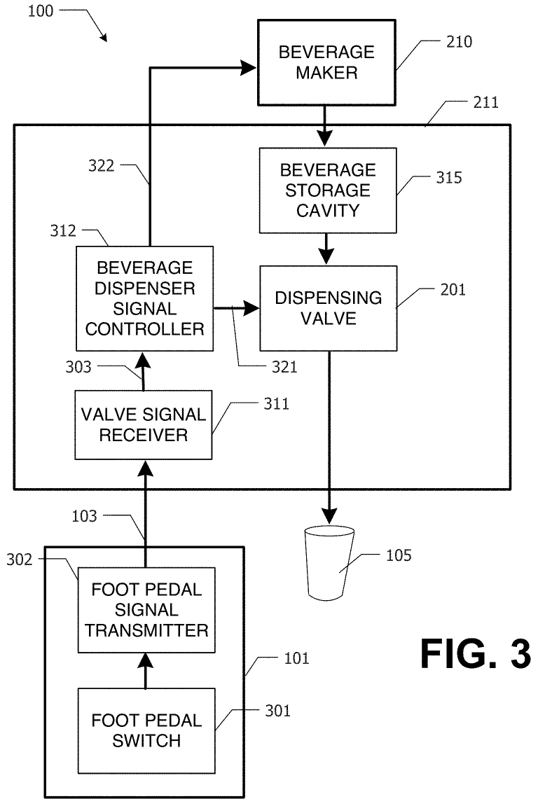

FIG. 3 illustrates a control signal diagram of an article of manufacture providing a foot pedal controlled dispensing coffee maker according to the present invention. FIG. 3 shows the foot pedal 101, the beverage maker 210, and the beverage dispenser 211 as described above in reference to FIG. 2. The foot pedal 101 comprises a foot pedal switch 301 and a foot pedal signal transmitter 302. The foot pedal switch 301 is a mechanical switch that closes when a user depresses the foot pedal 101 causing the control signal 103 to be generated. The foot pedal signal transmitter 302 comprises a circuit to send the control signal 103 in a form used in a particular embodiment from the foot pedal 101 to the beverage dispenser 102. For example, when the control signal 103 is an electrical signal the foot pedal signal transmitter 302 transmits the control signal 103 through a wired or wireless connection. For a hydraulic control signal 103, the foot pedal signal transmitter 302 will control the pressure applied to the hydraulic fluid to send the indication of the foot pedal switch 301 being closed. For a mechanical control signal 103, the foot pedal signal transmitter 302 manipulates the control signal wire as needed to send this signal indication.

The beverage dispenser 211 is shown in FIG. 3 as comprising the dispensing valve 201, the beverage storage cavity 315, a valve signal receiver 311, and a beverage dispenser signal controller 312. The dispensing valve 201 opens and closes based upon the control signal 103 being received by the valve signal receiver 311 and used by beverage dispenser signal controller 312. The dispensing valve 201 operates in the manner disclosed above in reference to FIG. 2. The beverage storage cavity 315 is the insulated container that holds a beverage provided by the beverage maker 210 before it is output by the dispensing valve 201 to the user. The valve signal receiver 311 receives the control signal 103 in its transmitted form to provide a version of the control signal 303 that may be used by the beverage dispenser signal controller 312.

The beverage dispenser signal controller 312 controls the generation of a dispensing valve open signal 321 that is sent to the dispensing valve 201 to open and close the valve to dispense the beverage. In the example of FIG. 2, the control signal 103 may be passed to the dispensing valve 201 as the dispensing valve open signal 321 with minor if any modifications. In other embodiments, the beverage dispenser signal controller 312 may provide additional control over the dispensing valve open signal 321. For example, the dispensing valve open signal 321 may be activated to open the dispensing valve 201 for a fixed period of time as determined by a timing circuit (not shown) regardless of how long a user depresses the foot pedal 101. Such a feature may prevent beverage cups from overflowing and creating a mess should a user depress the foot pedal 101 for too long.

The timing circuit may be implemented as a digital timer using an incrementing counter circuit to measure a specified amount of time the dispensing valve 201 is to be open. The timing circuit also may be implemented as an analog RC timing circuit in which a capacitor is charged at a rate controlled by a corresponding resistor to measure a specified amount of time. Other timing mechanisms also may be used. If a timing circuit is included within the beverage dispenser signal controller 312, the dispensing valve open signal 321 is activated when the control signal 103 is activated as disclosed herein. The dispensing valve open signal 321 is deactivated by the beverage dispenser signal controller 312 when the timing circuit indicates that the specified period of time has passed. The beverage dispenser signal controller 312 will then ignore the control signal 103 until the user steps off of the foot pedal 101 to reset the control signal 103 to a deactivated state.

The beverage dispenser signal controller 312 may estimate a volume of beverage that passes through the dispensing valve 201 using a sensor measuring a rate of flow through the dispensing valve 201 over a time period in which the dispensing valve 201 is open to dispense a single serving of the beverage. The beverage dispenser signal controller 312 also may estimate a volume of beverage that passes through the dispensing valve 201 by measuring a decrease in the level of beverage within the beverage storage cavity 315 when the dispensing valve is open.

In an embodiment that is capable of measuring an amount of beverage within the beverage storage cavity 315, the beverage dispenser signal controller 312 may determine that the beverage dispenser 211 does not possess enough beverage to open the dispensing valve 201 and provide a proper amount of beverage. In this latter case, the beverage dispenser signal controller 312 may not activate the dispensing valve open signal 321 until the beverage storage cavity 315 has been refilled. The beverage dispenser signal controller 312 may generate an empty dispenser signal 322 that is sent to the beverage maker 210 when the beverage storage cavity 315 is empty.

Even though particular combinations of features are recited in the present application, these combinations are not intended to limit the disclosure of the invention. In fact, many of these features may be combined in ways not specifically recited in this application. In other words, any of the features mentioned in this application may be included in this present invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture providing a foot pedal controlled beverage dispenser according to the present invention, the beverage dispenser comprises:
a beverage dispenser having a beverage storage cavity and a beverage dispenser signal controller;
a dispensing valve coupled to the beverage storage cavity and operating under the control of the beverage dispenser signal controller; and
a foot pedal communicatively coupled to the beverage dispenser signal controller providing an input signal to open the dispensing valve.

2. The beverage dispenser according to claim 1, wherein the beverage dispenser further comprises a beverage maker coupled to the beverage storage cavity to supply beverage liquid for dispensing.

3. The beverage dispenser according to claim 1, wherein the beverage dispenser further comprises a valve signal receiver connected to the beverage dispenser signal controller to receive the input signal from a foot pedal signal transmitter within the foot pedal.

4. The beverage dispenser according to claim 3, wherein the input signal is transmitted from the foot pedal signal transmitter to the valve signal receiver using a wired connection.

5. The beverage dispenser according to claim 3, wherein the input signal is transmitted from the foot pedal signal transmitter to the valve signal receiver using a wireless connection.

6. The beverage dispenser according to claim 5, wherein the wireless connection comprises a Bluetooth signal.

7. The beverage dispenser according to claim 1, wherein the beverage storage cavity is a thermally insulated container.

8. The beverage dispenser according to claim 2, wherein the beverage maker automatically refills the beverage storage cavity when the contents is below a defined volume.

9. The beverage dispenser according to claim 2, wherein the beverage maker refills the beverage storage cavity when the contents when instructed by the beverage dispenser signal controller.

10. The beverage dispenser according to claim 2, wherein the beverage dispenser signal controller opens the dispensing valve when receiving the input signal.

11. The beverage dispenser according to claim 2, wherein the beverage dispenser signal controller opens the dispensing valve for a predetermined length of time starting when the input signal is received.

12. The beverage dispenser according to claim 2, wherein the beverage dispenser signal controller opens the dispensing valve when receiving the input signal.

13. The beverage dispenser according to claim 2, wherein the beverage dispenser signal controller opens the dispensing valve to dispense a predetermined volume of beverage starting when the input signal is received.

14. The beverage dispenser according to claim 11, the predetermined length of time is measured using a digital counter within the beverage dispenser signal controller.

15. The beverage dispenser according to claim 1, the beverage dispenser further comprises a hand-operated switch communicatively coupled to the beverage dispenser signal controller.
